(19) United States
(12) Patent Application Publication
(10) Pub. No.: US 2007/0203743 A1
(43) Pub. Date: Aug. 30, 2007

(54) Method And Program For The Preparation Of Dental Work

(76) Inventor: Manfred Pfeiffer, Dubai (AE)

Correspondence Address: WOOD, PHILLIPS, KATZ, CLARK & MORTIMER, 500 W. MADISON STREET, SUITE 3800, CHICAGO, IL, 60661, US

(21) Appl. No.: 10/571,455

(22) PCT Filed: Sep. 13, 2004
(86) PCT No.: PCT/EP04/10206

§ 371 Date: Jan. 8, 2007

(30) Foreign Application Priority Data
Sep. 11, 2003 (EP) 03020686.6

(51) Int. Cl. G06Q 50/00; G06F 9/46

(52) U.S. Cl. 705/2; 705/8

(57) ABSTRACT

The invention refers to a method, to a computer program and to a data processing machine for the preparatory work of dental treatment. This invention in particular considers technical parameters concerning the order of the individual treatment steps. For one embodiment, it is intended to issue parts of the treatment sequence plan and to input data via handwriting.

Dentists perform complex technical procedures when treating the denture of a patient, this work—besides the actual dental examination, treatment and control—in part also comprising the work of other people of related occupations like e.g. dental technicians and other specialists for producing individually adapted technical products and performing respective laboratory work. These methods and the relating preparatory work become increasingly complex. Moreover, also data processing machines and computer programs are more and more employed in dentist's practices in order to record and administer data for specific treatment complexes.

In the following, the dentist's work will be regarded in respect of its property as a technical occupation. Although the treatment of the human body itself is excluded from patentability for reasons of missing susceptibility of industrial application, it is nevertheless undoubtedly technical.

The same also applies to the relating preparatory work, i.e. the operations scheduling including project design, construction, production of prototypes, etc., which—as well as in the production of complex technical products—also constitutes a part of technical production processes.

The present invention is thus based on the object to provide improved possibilities for the technical preparation of dental work.

The invention is directed to a method for preparatory dental work comprising the steps of:
collecting data for a dental treatment project in a data processing machine,
recalling predetermined operation schedule data from an operation schedule memory of the data processing machine,
wherein the operation schedule data are assigned to the treatment project data and contain temporal parameters for the treatment steps belonging to the treatment project, wherein the temporal parameters describe the temporal order of treatment steps in the treatment project,
creating a treatment sequence plan from the operation schedule data, the former of which comprises a number of treatment units with respective appointments, wherein respective treatment steps are assigned to the treatment units, and wherein the assignment of the treatment steps to the treatment units and to the appointments considers the temporal parameters contained in the operation schedule data.

The invention is further directed to a respective computer program product and to a data processing machine, which is programmed accordingly.

In the following description, there are no further distinctions between these different patent categories, so that the disclosure is to be understood as well in respect to the method, the computer program product and to the data processing machine.

The invention assumes, that preparatory dental work at first produces data for a future treatment project, e.g. because the dentist—when examining a patient—has found, that a specific tooth has to be provided with a dental bridge, while neighbouring teeth have to be provided with dental crowns. The term “treatment project” here means the treatment steps, which are planned and accomplished in one common planning context.

The method according to the invention is adapted such that the data belonging to the treatment project, which e.g. may characterize a dental bridge and two dental crowns at neighbouring teeth, are used for searching and recalling assigned operation schedule data from an operation schedule memory in a data processing machine. In these operation schedule data the technical details of the treatment steps belonging to the treatment project are memorized; for further illustration reference is made to the example. In particular, the operation schedule data—as an essential difference to conventional administrative programs for dentists—contain temporal parameters for the treatment steps.

Conventional programs have namely been restricted to the aim to compile the necessary information for a uniform and correct generation of invoices and, optionally, for automatically generating a treatment or cost plan or an invoice. In contrast to this, the invention should also be involved in the technical preparation of dental work. For this aim, the operation schedule data contain technical details of the treatment steps in the meaning of temporal parameters, namely at least parameters describing the chronological order of treatment steps within a treatment project.

Thus it is possible in the method according to the invention to supply the dentist with a prepared overview for his preparatory work, wherein this overview is provided via the program and deals with the coming up treatment steps in the correct chronological order and, optionally and so far as being appropriate, in the correct temporal context. The dentist can thus dispose of a preset scheme of treatment steps in a chronological order and fix respective treatment sessions with respective appointments. Thereby, he will not just be supported in his preparatory work, so that the danger to forget important or at least optionally reasonable treatment steps is reduced (in case of accordingly well kept operation schedule data one can even ensure a true completeness)—also the temporal aspect of the technical contexts in the meaning of chronological orders and simultaneity (these contexts referring to the technical preparatory work, i.e. to medical and technical preparatory work in this case) can be taken into consideration, thereby excluding respective mistakes.

With these operation schedule data, the method or program according to the invention can then create a treatment sequence plan containing a number of treatment units with their respective appointments. These treatment units may be treatment sessions for which the patient visits the doctor's practice. They may also constitute specific, temporally fixed treatment steps or groups of treatment steps to be accomplished in a temporal context, which are to be performed in the patient's absence in the doctor's practice, in a collaborating laboratory, etc. This treatment sequence plan considers the mentioned temporal parameters when assigning the treatment steps to the treatment units. The actual appointments can then—depending on the embodiment—be entered by the dentist or the staff at the doctor's practice, optionally after having consulted the patients or the laboratory, or they may also in part be automatically generated by the program itself, e.g. when there are specific temporal schemes being mandatory right from the beginning and thus not requiring direct agreement with the patient.

Expressed in a simplified and abbreviated manner, the invention thus intends to introduce temporal correlations and the temporal dimension of preparatory work as a technically relevant factor into a dental program, thus allowing to use this program for preparatory work. This is of particular importance since the technical progress in dentistry goes along with increasingly complex procedures and because the temporal correlations are not implicitly simple or allow to be overlooked without making mistakes. Moreover one has to coordinate the collaboration of different specialists in charge, besides the dentist himself e.g. also the oral surgeon, a special assistance or the dental technician, and also the procurement and provision of material and auxiliary equipment.

There is a major tendency to the “complete treatment” of the denture, i.e. to exhaustive and more or less universal treatment projects, which—in cases of success—are merely followed by maintaining the state thereby achieved. On the other hand, there is a strong interplay between different treatment steps applied to the patient and in particular also between those treatment steps, which include treatment parts being performed outside the range of works directly applied to the patient himself. These treatment steps prerequisite or cause each other, impede each other or may also be performed together in an efficient way.

The term “treatment step” here by the way means any single part of the treatment project being within the context of the dental therapy, thus also including collaborations of the laboratory, the services of the oral surgeon and other services not directly belonging to the dentist's work applied to the patient. The term “treatment steps” in particular also comprises mere examinations and controls, in which the patient's body or products intended therefore, are not manipulated in an actual sense.

In particular, one often has to consider relevant minimal intervals between different treatment steps like e.g. technically required minimal preparation periods and processing times of a laboratory or technician, minimal integrative healing periods until exercise tolerance, minimal healing periods of inflammatory processes after a treatment and the like. In a preferred embodiment, the invention intends that the temporal parameters in the operation schedule data include at least the essential intervals of the minimal intervals between the treatment steps and that the program in consequence displays a reaction, if these minimal intervals in the timetable of the treatment project, thus in assigning appointments to the treatment units, are disregarded.

The program in case of this reaction can produce a warning signal in the form of a print-out, a screen display signal or an acoustic signal or may also cause a blockade (allowing to be revoked by the operator) of the variation.

It is preferred that the treatment sequence plan can be varied by a user, e.g. by the dentist or his staff, in an interactive manner. One example is the manual entry of appointments. However, the invention also includes embodiments, in which the fixing of appointments is achieved automatically, optionally in agreement with other organization programs, and in which in any case changes not respecting the mentioned temporal parameters can not be accomplished.

It is particularly preferred, that the user varies the treatment sequence plan in the course of accomplishing the treatment project in dependency on examination and treatment results, and that the program preferably also requests the user to confirm or change individual parts of the treatment project in dependency on such results.

It is moreover preferred that, for individual treatment units, in particular for treatment sessions with the patient, one can create and output check lists, wherein these check lists are in particular printed out on a sheet or displayed on a monitor. The dentist or the staff possibly not being familiar with a directly computer-aided work can therewith perform individual treatment units in the known way by using directives in the form of a list without being obliged to gather information about the entire treatment project memorized in the data processing machine.

In a similar manner it is preferred to create und output appointment leaflets in particular for the patient in order to ensure compliance in respect of given appointments in a conventional manner.

Moreover, the method and program according to the invention may assign the treatment project data not only to the already mentioned aspects of preparatory work but may also assign them to fee schedule numbers or numbers of laboratory price lists, (e.g. of the GOÄ, the GOZ, the BEB/BEL) and thus facilitate the incorporation of the bookkeeping aspects of the treatment project or a coordination with a respective administration. In particular, the program may automatically create invoice proposals including proposals for laboratory invoices and/or cost plans.

As explained above the treatment sequence plan can be interactively varied by a user. An important embodiment of the invention is adapted to issue the treatment sequence plan or at least a part of the treatment sequence plan by the data processing machine, together with corresponding individual treatment steps. In particular, the output can be realized as a display on a monitor or as a printout, e. g. on a file card or on a simple sheet of paper.

Thereafter, in this embodiment, data to the issued part of the treatment sequence plan is entered by handwriting. Here, “handwriting” means a hand-guided movement of a writing utensil, but it does not necessarily stand for writing in a classical meaning, i. e. with a dye on paper. E. g. “handwriting” implies also the hand-guided writing on a touch-sensitive monitor. This handwritten input should be realized on the printed treatment sequence plan or on the displayed one on the monitor, i.e. the input is “inserted into” the printout or the display respectively. Thereafter, the data processing machine recognizes the input data either, in case of writing on the touch-sensitive monitor, by electronic analysis or by scanning of a printout. One can also think of mixed cases by the way, e. g. a printout on a substrate, which is then hand-labelled on a support recognizing the handwriting, such that the scanning can be omitted.

In the simplest case, the handwritten data is acquired simply in terms of its presence in specified fields. For this, the output (the term “output” shall cover printout and display on a monitor) contains blank fields, thus writable areas, wherein a fixed relationship between the location of these areas and the meaning of the labeling is predetermined. E. g. a labeling in specified blank fields can be understood as ticking-off, and a labeling in other fields, which are already labeled by the data processing machine, can be understood as crossing-out.

In a preferred and more elaborate version, however, the handwriting is read in terms of a script recognition (OCR, Optical Character Recognition) as actual script, what does not, particularly if the input is in block letters, bring along essential technical difficulties. Also in case of an actual script recognition, it is by the way preferred, that an informal crossing-out is still admissible and recognized as such, e. g. such that in case of hand-labeling which exceeds a specific threshold for hand-labeling of an actually machine-labeled field, this is assessed as a crossing-out of the content of this field, e. g. as a crossing-out of a treatment step.

First of all, the program provides sound information for the treating dentist by presenting a treatment sequence plan, thus avoiding overlooking or faulty reception of information; as a consequence the program ensures a state-of-the-art treatment. E.g. the program can—as a precaution—cause the dentist to perform a vitality test of a tooth before it is capped with a crown. That is to say, if this would remain undone because of carelessness, this would be an error in treatment. In addition, it can enable feedback, i.e. corrections, confirmations or completions of the treatment sequence plan, for the treating dentist or a member of the staff in an especially simple and thus efficient way. This can be done easily, in the described way by handwriting—virtually like writing on a memo—and thus also by persons, who are not accustomed or inclined to the use of data processing machines. In doing so, this naturally yields all possibilities already mentioned before for the handwritten data input, e.g. the variation of details of the treatment sequence plan, e.g. rescheduling an appointment.

If the output is realized as a printout, it is especially preferred to generate this printout outside of the respective treatment room. Many users resisted the use of conventional dental administrative programs within the treatment room. The generation of a printout and the possibility of handwritten feedback according to the invention thus provide a convenient possibility for the dentist and the staff for including the program and its supporting effects, on that account, without the need to deal with a data processing machine inside the treatment room itself.

Of course, the invention can also be operated inside the treatment room itself, in particular, if the output corresponds to a display on a monitor. In this case, the hand labeling on a corresponding “touch screen monitor” can help reduce such user reluctance due to the beneficial ergonomics. Scanning of the labeled printout can again be realized outside of the treatment room.

When using actual printouts, it is furthermore preferred, to provide them with a barcode, which allows for an identification of documents, particularly an identification of the treatment sequence plan or of the corresponding part of it. This barcode can allow for a fast pre-assignment during the described scanning process, but, if needed, also independent thereof allow for a fast clarification to which patient or to which treatment project respectively the corresponding printout belongs, by reading out the barcode with an optical reading pencil.

In case of a printout, it is furthermore preferably intended, that the printout comprises an area, which is not covered by the scanning process. This facilitates the speed and reduces the amount of data to be processed. This area can be used for handwritten comments and notes, which are not mandatory input for the program. The corresponding printouts comprising these notes can then allow for a more extensive treatment documentation, in particular if they correspond to classical file cards, which are usually used for documentation in dentist's practices.

The printout can comprise allocation lines to facilitate scanning of its tabulated layout. In particular the allocation lines can be embodied by an arrangement of small boxes based on drawn lines, but they can also be embodied by boundary lines followed by the machine labeling on the printout. Thus, an easier spatial allocation whilst scanning can be realized, in particular a determination of the center or a parallel adjustment.

During character recognition, either by scanning or in a different way, recognition uncertainties can occur. Here, it is preferred, that the display of the recognized treatment sequence plan (or a part of it) on the monitor optically marks such problematic areas, in particular by coloring the background of the corresponding field.

The handwritten input can include a confirmation or an authorization by the dentist himself. Thus, it is quasi-recorded, that a treatment step which is contained in the treatment sequence plan, was actually performed as a service. Only treatment steps, which are confirmed in this way, are actually considered for accounting. Therein, it is preferred, that the dentist accomplishes this confirmation by a handwritten date input—or with a handwritten date input—at the time of performing the service. In particular, the output, on which the handwritten confirmation is realized, can omit, i.e. leave out, the corresponding date of the treatment sequence plan, which date should thus usually correspond to the date to be entered. In this case, the program can also indicate deviations, if applicable. In any case, a missing date is a plausible reason for the completion, which completion thus has an improved authenticity due to the absence of an issued output date. Furthermore, a handwritten shorthand for the name or a symbol can naturally be entered by the dentist, which symbol can have the nature of a signature and, in addition to that, can allow for an allocation to the involved doctor in group practices.

Another aspect of the invention is that the program can produce estimates of expenditures of time and material for the treatment project, based on the treatment sequence data and potentially additional input data—by the way also independent of the output of treatment sequence plan parts and their hand-labeling. On the basis of these estimates, it can be determined with which accounting factor a sufficient invoice amount is realized, based on the corresponding fee schedule numbers to be applied. In case this accounting factor exceeds a threshold, e.g. a threshold set by a health insurance institution, the data processing machine can automatically issue a corresponding printout and thus cause the dentist to agree with the patient on the corresponding increased costs in written form.

The invention on the one hand displays the characteristics of a technical working method. Furthermore, the invention of course also refers to a computer program allowing for this method, this program existing in form loaded in a data processing machine, in a form memorized on a data carrier, or existing in any other form. Finally the invention also refers to a data processing machine having loaded a computer program according to the invention, this data processing machine thus being adapted to the method according to the invention. The term “data processing machine” thereby not only comprises individual machines but also complex data processing facilities, computer networks etc.

The invention in addition will be more closely illustrated by means of the following examples, wherein the individual features thereby disclosed are also relevant for the invention when being present in alternative combinations and wherein the description is only of exemplary character but will not restrict the scope of the invention.

What is shown is:

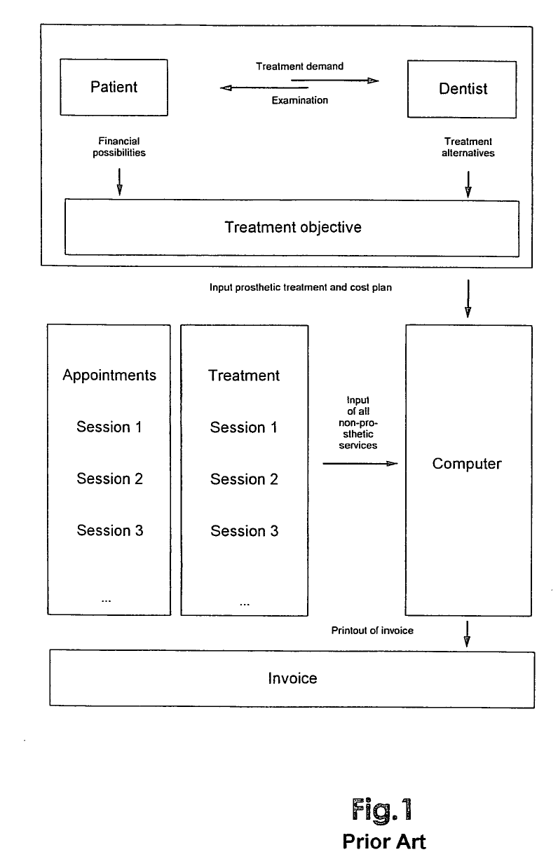

FIG. 1 a schematic overview of the course of the procedure for a dental treatment of a patient according to a conventional procedure;

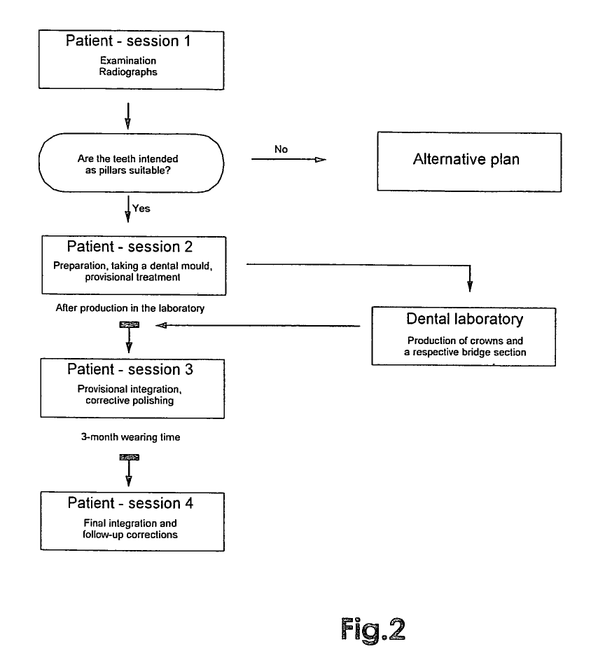

FIG. 2 an exemplary course of the procedure of a treatment project in order to illustrate the temporal parameters of the treatment steps;

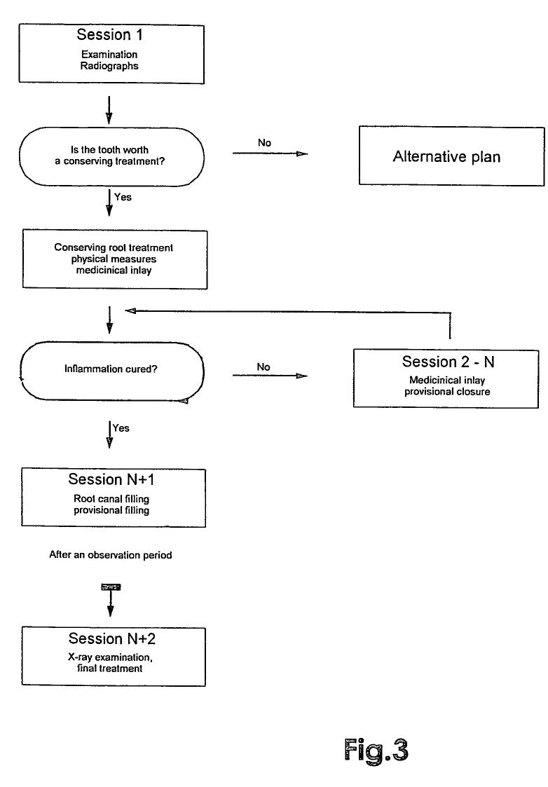

FIG. 3 a second exemplary course of the procedure of a treatment project;

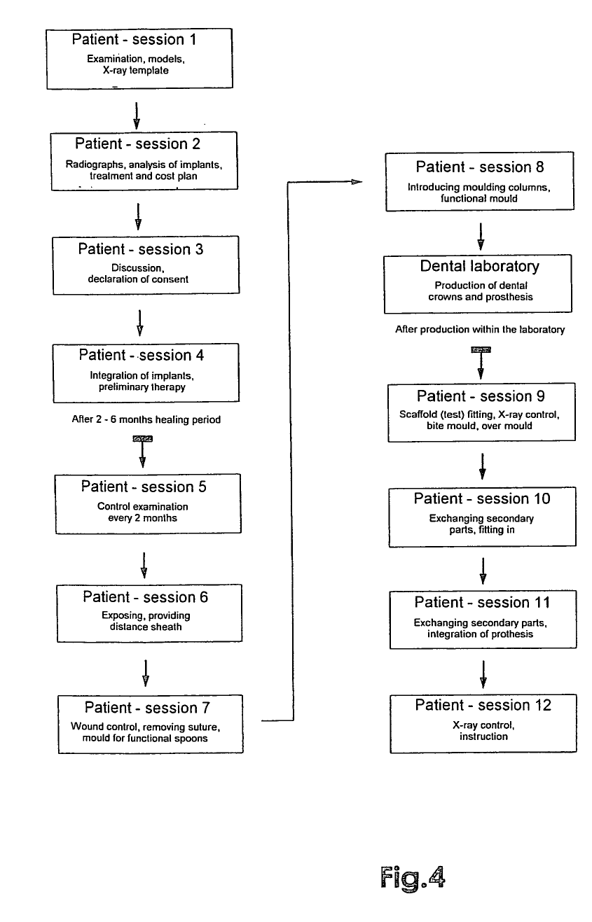

FIG. 4 a third exemplary course of the procedure of a treatment project;

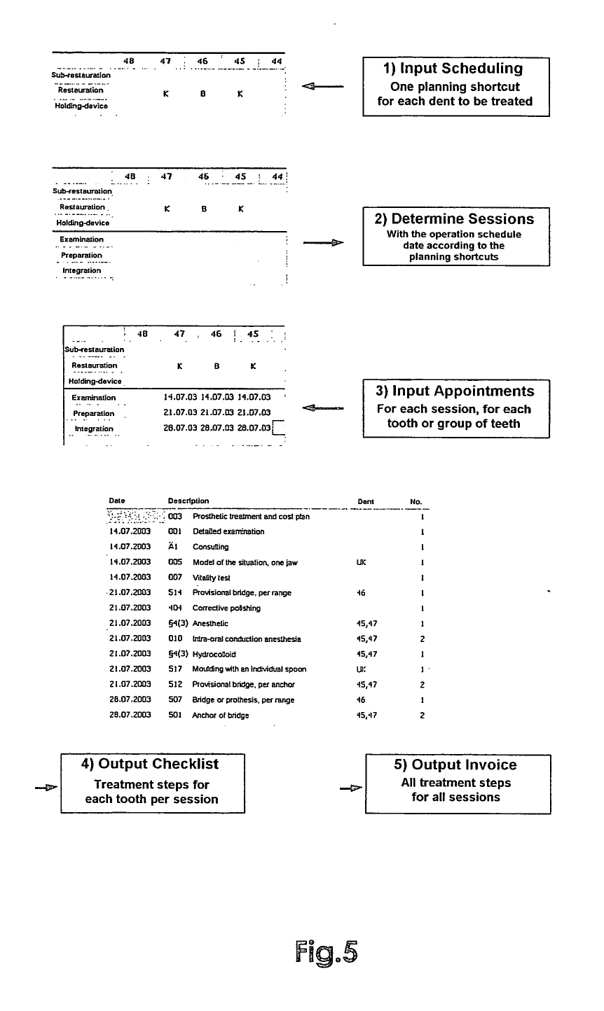

FIG. 5 a schematic diagram for illustrating the modus operandi of the program according to the invention;

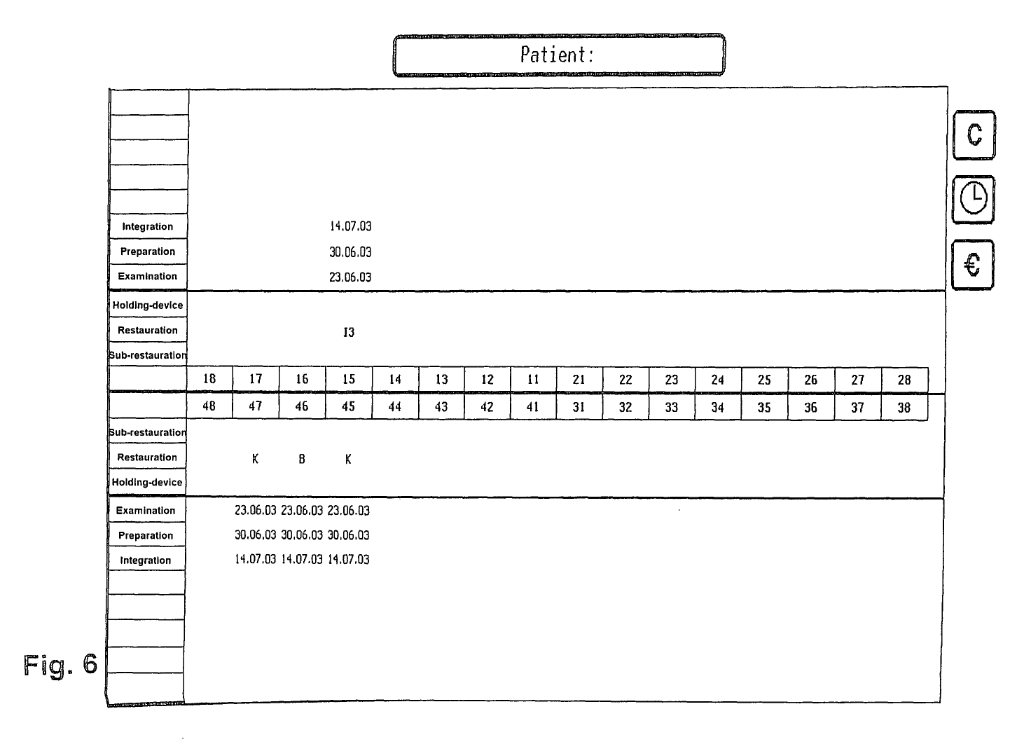

FIG. 6 an exemplary screen display of the program represented in FIG. 5

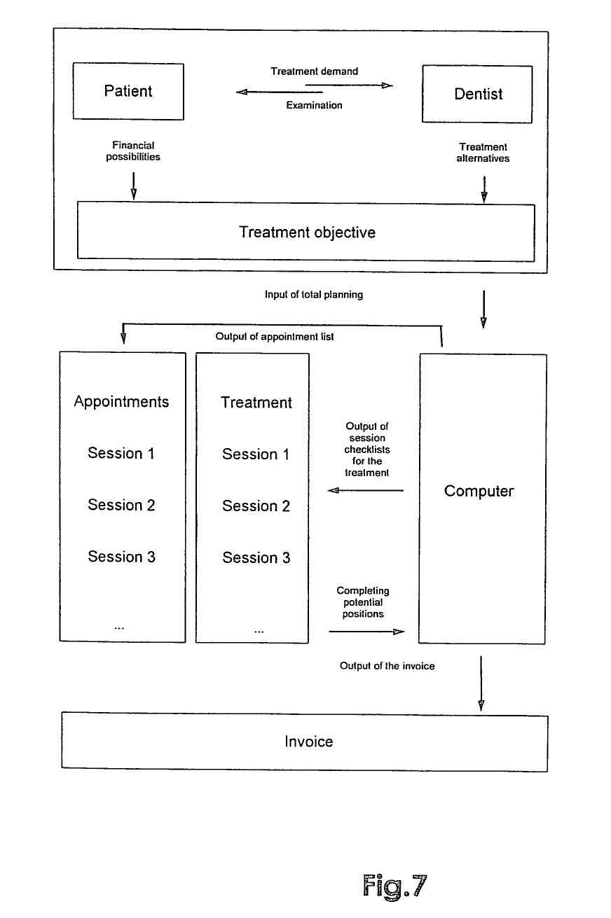

FIG. 7 a representation of the course of the procedure according to the invention, this representation being analogous to FIG. 1;

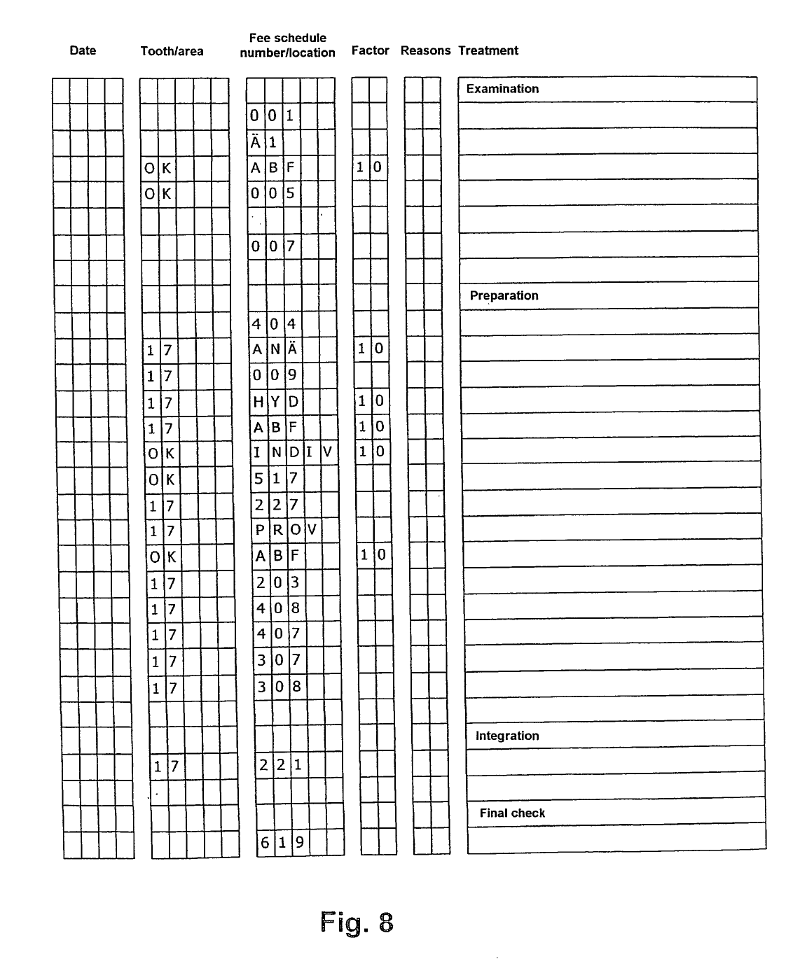

FIG. 8 an exemplary output of a part of a treatment sequence plan, which is related to a treatment session;

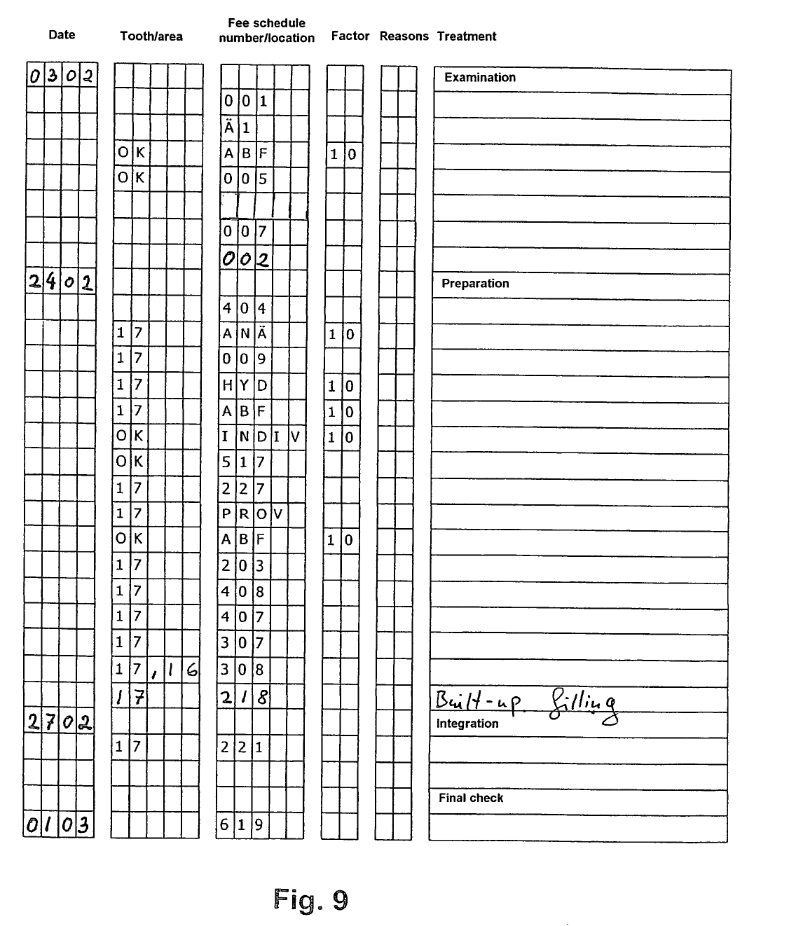

FIG. 9 the same output including handwritten input;

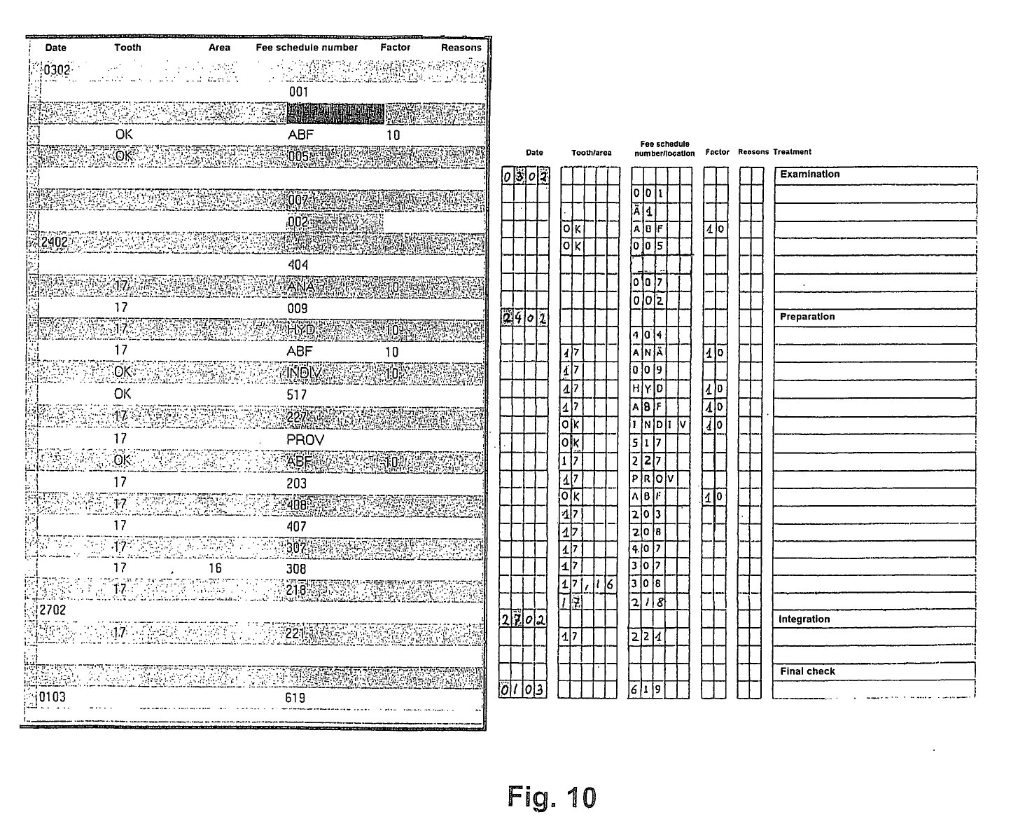

FIG. 10 the scanned output of FIG. 8 on the right hand side; with the display on a monitor following the recognition on the left hand side.

In general, the use of a computer program for dentists is realized in the context of the respective dental treatment as it is schematically depicted in FIG. 1. The patient will reveal his physical complaints and his anamnesis to the dentist and, so far as being recognizable for him, his needs for treatment. The dentist then performs a first examination, which will constitute the basis for choosing between different treatment alternatives in agreement with the financial capacity of the patient and for defining a therapeutic objective. This therapeutic objective is the summary of a treatment project to be realized in the following, this summary being conveyed to the patient.

The treatment project in many cases is subdivided into a pre-treatment, a prosthetic treatment as well as a follow-up control and, if necessary, corrections. For the prosthetic part, there will be created a treatment and cost plan, which covers the major part of the total expenses. This is realized by means of a computer program into which further services belonging to different treatment units can also be entered during the course of the treatment project. The treatment units in this case are a first, a second and a third session with different appointments.

The generation of a timetable for fixing appointments for the treatment is accomplished independently from the computer program. The computer program rather serves to collect the treatment data in order to generate treatment and cost plans and to facilitate the generation of invoices, optionally a completely automatic generation of invoices.

What is essential in this state of the art is, that the temporal planning of the individual sessions is accomplished without a relation to the treatment and cost plan and that the computer program collects the performed services only for bookkeeping reasons and can only differentiate between these services in a bookkeeping manner. The computer program thus does not offer any support in the preparatory work, since it is only supportive in bookkeeping and invoice matters.

On the other hand, there exist increasingly complex relationships between individual treatment steps in dental treatment projects. This at first has its cause in the technical progress in dentistry, in the second place one increasingly has to coordinate different persons and their collaborations inside and also outside of the dentist's practice, and in the third place there exists a tendency to the already mentioned “complete treatment” approaches.

For reasons of clarity, no especially complex examples will be presented in the following. Instead of this, FIG. 2 shows a simplified scheme of a more simple treatment project, namely the integration of a dental bridge in the lower jaw.

In the first treatment session, the patient is examined, thereby perhaps already taking radiographs if appropriate. Based thereon, it can be decided, if the teeth intended as pillars are suitable for this purpose, and, in the negative case, an alternative plan (which will not be further discussed in this context) is made. In case of a positive result, a second session is fixed in agreement with the patient, in which one performs a preparation, takes a dental mould and accomplishes a provisional treatment.

The dental mould is sent to a dental laboratory, which then produces respective dental crowns and a respective bridge section. This production process in the laboratory requires a certain processing time. Possible for example is a processing time of eight working days. A third treatment session, in which a provisional integration and a corrective polishing are accomplished, is then fixed with a respective minimal interval in agreement with the patient. The patient then has to wear the dental construction for a certain period of adaptation. An appropriate period may e.g. last three months in order to allow for the necessary healing process of a possibly traumatized pulp. The period of adaptation of three months thus prescribes an additional minimal interval between the third treatment session and a following fourth treatment session, in which a final integration and, if necessary, follow-up corrections are accomplished.

Temporal parameters to be considered in the present simple example thus are the technical processing time in the dental laboratory as a minimal interval between the second and the third treatment session and as well the healing period of three months as a minimal interval between the third and the fourth treatment session, all this in combination with the order of these treatment sections, which is predetermined by technical reasons.

On the other hand, provisional constructions - in dependence on their product quality—should not be maintained in the patient's mouth for a too long period, since otherwise their further fixation cannot be ensured and the danger of caries development can arise. Therefore, a maximal interval with an exemplary duration of four weeks between the second and the third treatment session may be reasonable. Although this maximal interval will not be reached in many cases, since appointments are anyhow given in a most rapid succession according to the patient's wishes, there again and again are cancellations in case of employed patients or as well appointment overlappings, which in practice are not recognized until a later moment. When accordingly arranging new appointments, is of great technical advantage to avoid too long intervals between the second and the third treatment session.

Analogous arguments are also valid for the period between the third and the fourth treatment session. In this case, e.g. a period of adaptation of one month for the provisionally inserted dental crown/bridge system should not be exceeded.

A further example for the illustration of temporal parameters is shown in FIG. 3, which illustrates a conserving root treatment in a gangrenous pulp. The destroyed pulp has to be removed and the root canal to be treated and filled in the following.

During the first treatment session, one again performs a first examination and, if possible, already an evaluation of the radiographs. Like in the first example, an alternative plan to be found in a negative case is not further described. What is realized in the positive case is a treatment of the root canal, physical measures, which will not be further described, and a medicinal inlay in order to stop inflammation.

After a certain minimal interval of three days it will then be examined, if the acute inflammation has been cured. This minimal interval is reasonable in technical respects, since a premature examination will lead to a positive result only with a very low probability. On the other hand, one also has to consider a maximal interval, since the (pre-)treated root canal is still unfilled. A possible maximal interval may e.g. be a period of about six months. In the first treatment session for re-examination it will then be evaluated, if the inflammation has been successfully cured. In the negative case, there will be a second or also further sessions for re-examination, possibly with a further medicinal inlay and provisional closure. After this first check-up session and after further sessions, one may again consider minimal and maximal intervals of e.g. three days or six months.

When the inflammation has been successfully cured, the root canal filling can then be accomplished during the same session or during a new session to be fixed. After an observation period of at least six to nine months there will be a further examination, in particular an X-ray examination and—in the positive case—a treatment via a dental crown.

This example already illustrates a larger number of temporal parameters in the meaning of minimal and maximal intervals between individual treatment steps or individual treatment units. It is to be understood, that no general mandatory statements can be made in respect to the question, in which cases one has to consider minimal intervals or maximal intervals or none of these intervals. This on the one hand is dependent on the diligence of the dentist in charge and on the other hand it is also a question of the inter-individual variability of the patients or the materials used in the individual case.

A third example in FIG. 4 schematically shows the treatment procedure for a so-called Cover-Denture-Prosthesis in the lower jaw, this prosthesis being anchored via implants.

A first treatment session is used for an examination and the creation of models in order to produce an X-ray template. In a second treatment session one takes radiographs, performs an analysis of the implants and prepares a treatment and cost plan. A third treatment session is then used for a detailed discussion on the issues with a declaration of consent from the patient, so that the implants can be integrated during a fourth treatment session. After a minimal integrative healing period in the range of two to four months for the lower jaw and six to nine months for the upper jaw there is a control examination in the course of a fifth treatment session, whereupon in a sixth treatment session the implants are surgically exposed and provided with distance sheaths for integrative healing.

A seventh treatment session, once more with a specific minimal interval of one week towards the sixth treatment session, is used for wound control, for removing the suture, for taking a mould for functional spoons, whereupon, with a further minimal interval of two weeks, moulding columns can be introduced and a functional mould be taken in an eighths treatment session. In the following, the dental laboratory will produce the dental crowns and prostheses during a typical processing time of three weeks. Thus, with a respective minimal interval, there will be a ninth treatment session with the patient, used for a scaffold (test) fitting, an X-ray control and for taking a bite mould and an overmould from the patient.

A tenth treatment session is used for exchanging the secondary parts and for a fitting in. In an eleventh treatment session again secondary parts are exchanged and the prosthesis is integrated, followed by an X-ray control and patient instruction in a twelfth treatment session taking place after another interval.

The above described treatment will take at least eight months, wherein not only the services of the dentist, but also those of the oral surgeon and the dental laboratory and also the procurement of materials and auxiliary equipment have to be coordinated temporally and professionally. This treatment illustrates the improvement in quality and safety, which can be obtained by a computer-aided preparatory work and coordination. The treatment period however should not exceed 18 months for the upper jaw and 9 months for the lower jaw, since the trabecular structure of the bone is only formed under (mechanical) stress. This maximal period in principle refers to the interval between the fourth and the eleventh session.

FIG. 5 then illustrates how the computer program according to the invention can be used for these aims. At first, so-called planning shortcuts for each tooth to be treated are entered into a matrix scheme partly depicted in the upper left corner of FIG. 5. This corresponds to the hitherto accordingly designated data collection of the treatment project. For example one enters the teeth 5-7 from the lower right part of the jaw (seen from the patient's perspective) according to the established enumeration as numbers 45-47, moreover entering the planning shortcuts K, B, K in the meaning of a restorative work with a dental crown (“Krone”), a bridge section (“Brückenglied”) and a further dental crown. The planning shortcuts as the collected data serve the program to recall respective operation schedule data for the planning shortcuts, these data being obtained from preset operation schedules memorized in an operation schedule memory. Opened according to the illustration of the diagram e.g. are respective fields each for the dental crowns and for the bridge element, these fields containing information for treatment sessions for examination, for preparation and for integration. However, the program via the operation schedule data also knows about the individual treatment steps of these treatment parts.

In a next step, the dentist can assign an appointment to a first treatment session, in this case 14.07.2003 for an examination in respect of all three teeth 45-47. In the further procedure, the program may then either preset windows in time for the following appointments for the preparation and integration, thus for the two treatment parts to follow, wherein these windows in time consider the preset minimal and maximal intervals; or it may indicate earliest possible appointments, which may then be postponed by the dentist in agreement with the patient; or it may just examine an appointment freely chosen by the dentist for compliance with the temporal parameters. In this case this may e.g. be such accomplished, that the computer program, after the 14.07.2003 for the treatment part belonging to the examination has been entered, requests to enter the second appointment for the preparation in a free manner. Here, the dentist has entered the 21.07.2003. Thereupon, the program has—under consideration of a minimal processing time of one week for the preparation of the dental crowns and the bridge—proposed the 28.07.2003 as an appointment for the integration, which in this case has been accepted by the dentist and the patient. If the given appointment had been postponed, the program would have respected a maximal interval of e.g. four weeks between the appointments for preparation and integration.

The lower, large field in FIG. 5 then shows in an exemplary manner various treatment steps being assigned to the different treatment parts, thus to the treatment sessions. These treatment steps are already assigned to respective cost figures or cost regulations/fee schedules via shortcuts preceding the clear text; in the last two lines they are allocated to specific teeth and jaw sections and quantified according to their number. This scheme can serve the dentist and also his staff as a check list for the respective treatment session. However it already allows beforehand for a technically and substantially qualified and in particular for a time-resolving overview over the entire treatment project in the meaning of a preparatory work plan. Moreover, the computer program may of course also be such designed, that it, by means of the present data, also supports the generation of an invoice at the respective times, e.g. by compiling a total invoice for all sessions at the end of the entire treatment project.

The program according to the invention is thus not restricted to offer support in bookkeeping tasks, but also allows for a technically qualified preparatory work in respect to the consideration of temporal parameters, this preparatory work in particular relating to appointment planning, procurement of materials and auxiliary equipment, as well as to the generation of check lists and thus to an improved control of working performance and procurement.

FIG. 6 for reasons of illustration shows a complete screen display for the fixing of an appointment according to FIG. 5, wherein in this case both jaws of the patient are shown in their entirety. FIG. 6 shows the entered appointments differing from those of FIG. 5 and, in addition, steps intended for the three treatment sessions on 23.06., 30.06 and 14.07.2003, these treatment sessions constituting a part of a treatment project (wherein this treatment part is designated by the planning shortcut I3) for tooth 15 in the left upper jaw. This part of the treatment project will not be depicted in detail. FIG. 6 illustrates that the program offers a very clear matrix-like overview over the entire treatment project via a vertical time axis and a horizontal allocation of teeth and the planning shortcuts familiar to the dentist and his staff. The buttons in the right section, labeled with C, the clock symbol and the Euro symbol serve to delete entered data, to fix appointments or to switch to the bookkeeping modus for generating an invoice or a treatment and cost plan. FIG. 7 serves a comparison with FIG. 1 and shows the procedure of the treatment project in an overview representation. The upper box thereby corresponds to FIG. 1 and thus not has to be explained once more. It may be additionally mentioned however, that the dentist is supported in the treatment of a patient in respect to the needs of treatment of the patient, the respective costs and the available alternatives by the overview function of the computer program facilitating this work. Thus one can also plan treatment projects by way of trial in order to support and illustrate advisory services. Unwanted treatment projects can then be deleted again. In the described manner, the treatment actually intended is planned as a treatment project, as it has already been described via FIGS. 5 and 6. Thereby, besides obtaining an overview over the total planning, one can also output appointment lists and session check lists for the individual treatment sessions and also for other parts of the treatment like laboratory work. During the process of the treatment project, one may furthermore carry out changes or receive a feedback in respect to the presence or abandonment of optional positions. During the total treatment project, all engaged persons moreover are allowed to get information about the planning and preparatory work and to organize and check their individual operations accordingly.

At the end of the treatment project one may again, in parallel to the state of the art, generate a total invoice. However, the generation of invoice may additionally perform a temporal differentiation, thus an assignment of individual invoice items to specific treatment sessions. Thereby, the assignment of costs to the performed treatment is improved in the meaning of a cost transparency and increased trustworthiness for the patient.

The FIGS. 8, 9 and 10 illustrate the aspect of the invention concerning the output of a part of a treatment sequence plan—here comprising four sessions with the patient—and the handwritten input. These illustrations are related to the program and the method, which are explained by means of the FIGS. 1 to 7, they are, however, based on a slightly deviating dental case.

FIG. 8 shows a file card comprising a bar code in its upper right. This file card can either be a file card in a physical meaning, printed by a computer printer, or be embodied in the graphical layout of a display on a monitor. In the latter case, the barcode would in any case not be necessary, if not an additional printout is realized. For simplicity, a printout is assumed below, without changing any essential characteristics of the example.

The printout shown in FIG. 8 comprises six vertical columns, each column displays a title to improve comprehension. The first column is intended for the temporal data of the individual treatment steps. This column is empty in its issued condition. However, it shows a division in individual fields by allocation lines, nevertheless.

The second column relates to the tooth affected by the treatment—or to the corresponding area. Thereby e.g. OK stands for the whole upper jaw and 17 stands for a specific dent (compare FIG. 6). This column is already labeled by the data processing machine, thus it contains written data.

The third and next column refers to corresponding fee schedule numbers, which are assigned to the individual treatment step from different fee schedules. E.g. the abbreviation ABF stands for moulding material, the abbreviation HYD stands for hydrocolloid and the abbreviation INDIV stands for an individual spoon, furthermore, the abbreviation PROV stands for a provisional solution. Also this column is already labeled when issued. The term “location” in the third column means, that in case of fillings, also the location of the filling can appear here, which then also appears on the invoice. In such cases, the fee schedule number can be infered from the location, such that the information about the location can replace the fee schedule number. Then follows a column with corresponding factors, which are, in this case, also predetermined by the program. These can correspond to fixed presets or also to factors which are determined with the help of estimated time and material expenditures in the explained way; which may be to be associated to an agreement with the patient, if appropriate. The registered factors 1.0 are assigned to positions of material for which they are to be applied anyway. In this embodiment, the other fields would be to be completed by the dentist if and only if he wants to deviate from the standard factors 2.3 for dental services and 1.8 for x-ray services, respectively. Without entry, the program applies the corresponding standard factors. In this example, no such deviating entry exists.

The last column is intended for comments on the treatment in clear text. This column is also already labeled, namely with catch words associated to the respective sessions, which catch words improve the overview. Further, in this embodiment, the program leaves this last column open for comments.

The treating dentist sees this file card in front of him in advance of the treatment and during the treatment, and he completes it by handwriting, as depicted in FIG. 9. This can be realized with a ball pen or also with a corresponding pen on a sensoric support, onto which the file card is applied (and finally this can also be realized as a display with a file card layout on a touch-sensitive monitor itself (touch screen)).

Initially, one recognizes that in the next date column, ahead of a block of treatment steps, e.g. ahead of the block of treatment steps with the fee schedule numbers 001, Ä1, ABF, 005, 007, the date of the corresponding session is completed by handwriting, in this case it is 03.02. At the same time, this entry constitutes a confirmation of the accomplishment of the specified treatment steps. Furthermore, a treatment step 002 is amended at the end of the session by handwriting.

Ahead of the next block of treatment steps, 24.02. then 27.03. and, finally 01.03. is entered in a corresponding way. At the end of the session of 24.02. the treatment step with the fee schedule number 308 was, in addition to tooth 17, also accomplished for tooth 16, what is amended in the second column by handwriting. Furthermore, an additional built-up filling with the fee schedule number 218 was accomplished for tooth 17, what is amended in the right column with handwritten treatment comments. In this example, it is a matter of an individual crown, in which, according to the amended entry, a built-up filling became necessary. In the following, the medical details shall not be presented in any more depth, since they are not essential for the principle of the invention.

FIG. 10 shows on its right hand side the file card of FIG. 9, which is completed by handwriting and which is already scanned in the shown appearance. The barcode in its upper right allows for a direct allocation of the document. By the way, a display appears on the monitor, which display is shown at the left hand side of FIG. 10; the display contains also the added handwritten details, in addition to the anyway predetermined content according to FIG. 8. One can observe that the right column with the clear text comments is not acquired, since this column is not essential for the program.

E.g. in the date column, one observes, that the second and the fourth numeral of the first date, the first numeral of the second date, the second numeral of the fourth date and the first numeral of the fourth date and, finally the second numeral 7 of the handwritten amendment about the built-up filling, were impaired by some uncertainty, and that the program suggests a check by changing the background of these numerals. The comparison with the left part of FIG. 10 shows, however, that the recognition was correct. Further, the program takes the data as a confirmation by the dentist of the corresponding session, i.e. of the following treatment steps.

The FIGS. 8 to 10 show a file card adapted to be read by computing facilities within the context of dental treatment, containing a part of the treatment sequence plan, which is related to several sessions, or also containing the whole treatment sequence plan. The column containing comments on the treatment and not covered by the computing facility serves only as an orientation for the dentist and for a more detailed paper documentation. Further, the file card is completed during the treatment in the other columns with the up-to-date session data and additionally incurred services and also corrected, if necessary. As a matter of fact, with this approach, a state-of-the-art treatment in an ISO-9000-environment can be anticipated. E.g. thereby necessary vitality tests or x-ray controls before a preparation are not forgotten anymore.

1. A method for preparatory dental work comprising the steps of:
collecting data for a dental treatment project in a data processing machine,
recalling predetermined operation schedule data from operation schedule memory of said data processing machine, wherein said operation schedule data are assigned to treatment project data and contain predetermined temporal parameters for the treatment steps belonging to said treatment project,
creating a treatment sequence plan from said operating schedule data, the former of which comprises a number of treatment units with respective appointments, wherein respective treatment steps are assigned to said treatment units, and wherein the assignment of said treatment steps to said treatment units and to said appointments considers said temporal parameters contained in the operation schedule data,
wherein the predetermined temporal parameters describe the temporal order of treatment steps in said treatment project.

2. The method according to claim 1, in which said temporal parameters describe minimal intervals between treatment steps.

3. The method according to claim 1, in which said temporal parameters describe maximal intervals between treatment steps.

4. The method according to claim 1, in which treatment project data for non-dental services like e. g. laboratory, construction of devices or provision of materials and/or auxiliary equipment are included in said treatment project data.

5. The method according to claim 1, in which said treatment sequence plan is interactively varied by a user.

6. The method according to claim 5, in which the variations of said treatment sequence plan are controlled in respect of compliance with said temporal parameters contained in said operation schedule data, and in which, in case of non-compliance, at least a blocking of the variation or a warning signal of said data processing machine is realized.

7. The method according to claim 6, in which said treatment sequence plan is varied in the course of accomplishing said treatment project in response to examination results/treatment results occurring in this process.

8. The method according to claim 1, in which treatment session check lists are created and issued.

9. The method according to claim 1, in which appointment leaflets are created and issued.

10. The method according to claim 1, in which said treatment project data are assigned to dental fee schedule numbers.

11. The method according to claim 10, in which said data processing machine automatically generates invoice proposals including proposals for laboratory invoices.

12. The method according to claim 11, in which said data processing machine automatically generates cost plans.

13. The method according to claim 1 comprising the additional steps of:
putting out at least a part of said treatment sequence plan including individual treatment steps,
putting in data relating to said issued part of said treatment sequence plan by hand-guided writing on said issued part of said treatment sequence plan.

14. The method according to claim 13, in which said output is realized as a printout outside of a dental treatment room.

15. The method according to claim 13, in which said output is realized as a display on a monitor and said input of data is realized on said displayed part of said treatment sequence plan by hand-guided writing on said display on said monitor.

16. The method according to claim 13, in which said output is realized as a printout and said input of data is realized on said printed part of said treatment sequence plan by handwriting on said printout and by scanning said hand-labeled printout, as well as by electronic recognition of said handwriting.

17. The method according to claim 16, in which said printout includes a bar code and said bar code identifies said printed part of said treatment sequence plan or said treatment sequence plan in total.

18. The method according to claim 16, in which said printout includes an area which is not covered by said scanning and said handwriting recognition, and which area is labeled by hand.

19. The method according to claim 16, in which said printout comprises a tabulated design with allocation lines and said allocation lines are used for at least one of determining the center and/or and the alignment of said printout during said scanning.

20. The method according to claim 13, in which a display on a monitor displays script recognition uncertainties after said data input by hand-guided writing.

21. The method according to claim 13, in which said treatment steps of said issued part of said treatment sequence plan are confirmed by a dentist within the scope of said data input by hand-guided writing.

22. The method according to claim 21, in which, in case of treatment steps to be confirmed, said output of said part of said treatment sequence plan leaves their date undetermined, and in which said confirmation by said dentist includes a handwritten date input.

23. The method according to claim 1, in which estimations of expenditures of time and material are accomplished by said data processing machine with the help of said operation schedule data for said treatment project, and in which, based thereon, accounting factors for fee schedule numbers are determined.

24. The method according to claim 23, in which after determination of said accounting factors, in case of an excess of specific thresholds, pre-printed forms to be agreed on by the patient are automatically printed.

25. A computer program product, wherein a data processing machine is adapted to the performance of the method according to claim 1 after having loaded the computer program.

26. A data processing machine, which has loaded a computer program according to claim 25 and is thus adapted to the performance of the method according to claim 1.
